(19) United States
(12) Patent Application Publication
(10) Pub. No.: US 2017/0099018 A1
(43) Pub. Date: Apr. 6, 2017

(54) ELECTRIC POWER TOOL

(71) Applicant: MAKITA CORPORATION, Anjo-shi (JP)

(72) Inventors: Akira TOMONAGA, Anjo-shi (JP); Masanori FURUSAWA, Anjo-shi (JP); Junya ISHIKAWA, Anjo-shi (JP)

(73) Assignee: MAKITA CORPORATION, Anjo-shi (JP)

(21) Appl. No.: 15/265,388

(22) Filed: Sep. 14, 2016

(30) Foreign Application Priority Data
Oct. 6, 2015 (JP) 2015-198604

(51) Int. Cl. H02P 1/16; H01H 9/54; H02H 11/00; B24B 23/02; B25F 5/00

(52) U.S. Cl. CPC H02P 1/16; B24B 23/028; B25F 5/00; H02H 11/00; H01H 9/548

(57) ABSTRACT

An electric power tool includes a relay, an electric circuit, and an operation member. The relay has a coil, contacts, and an on-switch. The relay is configured such that the coil is energized when contacts are closed by an on-switch being pressed, and contacts are held in a closed state by an electromagnetic force of coil when coil is energized. In the electric circuit, electric power from power source is supplied to motor and coil of relay, and contacts are connected in series between power source and motor. The operation member is configured to move in reciprocating manner between tool stop position at which the motor stops and tool drive position which the motor runs, where the operation member is configured to locate away from on-switch of the relay at the tool drive position and configured to press the on-switch at a position other than tool drive position.

### CROSS-REFERENCE

This application claims priority to Japanese patent application serial number 2015-198604, filed on Oct. 6, 2015, the contents of which are incorporated herein by reference in its entirety.

### TECHNICAL FIELD

The present invention generally relates to an electric power tool that has a function of preventing restart thereof, such that the electric power tool is not automatically restarted even when a power supply is recovered after the power supply has stopped, owing to, for example, a power failure etc. while a power switch of the electric power tool is switched on.

### BACKGROUND ART

Japanese Laid-Open Patent Publication No. H8-308098 discloses an electric power tool that has a function of preventing restart thereof As shown in FIG. 21 of this invention, the electric power tool of Japanese Laid-Open Patent Publication No. H8-308098 has a pre-voltage detection circuit 103 at a primary side of a power switch 101 and a post-voltage detection circuit 104 at a secondary side of the power switch 101. Furthermore, a time constant of the pre-voltage detection circuit 103 is set to be larger than that of the post-voltage detection circuit 104. Because of this circuit constant setting, when a voltage is simultaneously applied to the pre-voltage detection circuit 103 and the post-voltage detection circuit 104, an output voltage of the post-voltage detection circuit 104 becomes larger that that of the pre-voltage detection circuit 103 in a transition period. Accordingly, in a case where, for example, a power supply is recovered after the power supply has stopped owing to a power failure etc. while the power switch 101 is switched on, an output voltage of the post-voltage detection circuit 104 becomes larger that that of the pre-voltage detection circuit 103 in a transition period.

Both the output voltage of the pre-voltage detection circuit 103 and the output voltage of the post-voltage detection circuit 104 are input to a comparator 105. The comparator 105 outputs a stop signal for stopping a motor 108 when the output voltage of the post-voltage detection circuit 104 becomes larger than that of the pre-voltage detection circuit 103. In more detail, the stop signal for stopping the motor 108 output from the comparator 105 is input to a bi-directional thyristor 107 via a motor driving circuit 106, which causes the motor 108 to stop. Because of this process, even in a case where a power supply is recovered after the power supply has stopped owing to a power failure etc. while the power switch 101 is switched on, restarting of the motor 108 can be prevented.

In the electric power tool mentioned above, the pre-voltage detection circuit 103 is located at the primary side of the power switch 101 and the post-voltage detection circuit 104 is located at the secondary side of the power switch 102. Because of this construction, even when the power switch 101 is switched off, a current still flows in the pre-voltage detection circuit 103, and accordingly power in the form of standby power will continue to be consumed. Furthermore, because of the requirement for an element such as a bi-directional thyristor, etc., which is a heating element, to start and/or stop the motor 108, an additional dissipation structure to dissipate heat generated by the bi-directional thyristor etc. will also be needed.

In view of the above, there is a need in the art to prevent restarting of the electric power tool without using a heating element such as a bi-directional thyristor, in order to reduce the amount of heat generated in the tool and in order to conserve standby power. In one exemplary embodiment of the present disclosure, a relay can be used.

### SUMMARY

In one exemplary embodiment of the present disclosure, an electric power tool may have a relay comprising a coil, a contact, and an on-switch. The relay is configured such that the coil is energized when the contact is closed by the on-switch being pressed, where consequently the contact is held in a closed state by an electromagnetic force of the coil when the coil is energized. The electric power tool may also have an electric circuit in which electric power from a power source is supplied to a motor and the coil of the relay, where the contact is connected in series between the power source and the motor. Furthermore, the electric power tool may also have an operation member configured to move in a reciprocating manner between a tool stop position at which the motor stops and a tool drive position at which the motor is driven. The operation member may be configured such that it moves away from the on-switch of the relay at the tool drive position, and presses the on-switch at a position other than the tool drive position.

According to the embodiment, before the operation member is moved to the tool drive position, the operation member may press the on-switch of the relay to close the contact of the relay. As a result, the coil of the relay may be energized and the contact of the relay may remain in a closed state due to the electromagnetic force of the coil. When the operation member is then moved to the tool drive position, the operation member may be moved and positioned away from the on-switch of the relay. In other words, when the operation member is located at the tool drive position, the contact of the relay may remain in the closed state by the electromagnetic force of the coil to cause the motor to be continuously driven. Under this condition, for example, if a power plug of the electric power tool is pulled out from an outlet and power supply is interrupted, energization of the coil of the relay may be released, causing the contact of the relay may open. Thus, the motor may stop. Under this condition, even if the plug is connected to the outlet again, the contact of the relay may remain in the opened state because the operation member is located at the tool drive position away from the on-switch of the relay. Further, even if the power plug is connected to the outlet under a condition where the operation member is located at the tool drive position, the motor may be prevented from restarting. In this way, restarting of the electric power tool may be prevented without requiring use of a heating element such as a bi-directional thyristor, etc. Furthermore, in certain cases as described above when the operation member is not pushing the on-switch of the relay, the coil of the relay may not be energized, and accordingly standby power may be prevented from being consumed.

In another exemplary embodiment of the disclosure, the electric power tool may also have a motor start switch that is connected in series to the contact of the relay. The electric circuit may be configured such that electric power is supplied to the motor only when both the contact of the relay is closed and also when the motor start switch is turned on. The operation member may be configured to turn on the motor start switch at the tool drive position and to press the on-switch of the relay at the tool stop position. Furthermore, the operation member may be configured to turn off the motor start switch when the operation member is moved away from the tool drive position. Conversely, when the operation member is located at the tool drive position, both the contact of the relay and the motor start switch may be turned on, causing the motor to run. Furthermore, when the operation member is located at the tool stop position, the motor start switch may be turned off. Accordingly, when the contact of the relay is closed, the motor may remain in a stopped state.

In another exemplary embodiment of the disclosure, the operation member may have an opening into which an operation lever of the motor start switch is inserted, and it may also have a pressing portion that presses the on-switch of the relay. Then, when the operation member is located at the tool stop position, the operation lever of the motor start switch may be held at an off position within the opening and the pressing portion of the operation member may press the on-switch of the relay. Furthermore, during a movement of the operation member toward the tool drive position, the operation lever of the motor start switch may be moved to an on position by being pushed by an end edge of the opening of the operation member, and the pressing portion of the operation member may be moved away from the on-switch of the relay.

In another exemplary embodiment of the disclosure, the relay may have an off-switch that is configured such that when the off-switch is pressed, energization of the coil may be released to open the contact. The electric circuit may be configured to supply electric power to the motor when the contact of the relay is closed. The operation member may press the off-switch of the relay when the operation member is located at the tool stop position. During a movement of the operation member from the tool stop position to the tool drive position, the operation member may be moved away from the off-switch of the relay and may push the on-switch of the relay. The operation member may also be moved away from the on-switch of the relay at the tool drive position. Accordingly, under a condition where the operation member is located at the tool drive position, the operation member may be located away from the on-switch of the relay and the contact of the relay may remain in a closed state by the electromagnetic force of the coil. As a result, the motor can run. Furthermore, under a condition where the operation member is located at the tool stop position, the operation member may press the off-switch of the relay and accordingly energization of the coil may be released and the contact may open. As a result, the motor may not run, and remain in a stopped state.

According to the present teachings, the electric power tool can be prevented from restarting without using a heating element such as a bi-directional thyristor etc., which can reduce an amount of heat generated in the tool and suppress standby power.

### BRIEF DESCRIPTION OF THE DRAWINGS

FIG. 1 is an overall perspective view of an electric power tool such as a disc grinder according to one exemplary embodiment of the present disclosure.

FIG. 2 is a sectional view taken along arrow II-II in FIG. 1, which is seen from below the electric power tool in a sectional view.

FIG. 3 is a schematic circuit diagram showing an electric circuit diagram of the electric power tool.

FIG. 4 is a plan sectional view showing an operation link, a relay, and a motor start switch.

FIG. 5 is a schematic circuit diagram showing an electric circuit diagram corresponding to an operation of the electric power tool.

FIG. 6 is a plan sectional view showing an operation link, a relay, and a motor start switch.

FIG. 7 is a schematic circuit diagram showing an electric circuit diagram corresponding to another operation of the electric power tool.

FIG. 8 is a schematic circuit diagram showing an electric circuit diagram corresponding to another operation of the electric power tool.

FIG. 9 is a plan sectional view of the electric power tool according to another exemplary embodiment of the present disclosure.

FIG. 10 is a perspective view showing an operation link and a relay of the electric power tool.

FIG. 11 is a schematic circuit diagram showing an electric circuit diagram corresponding to another operation of the electric power tool.

FIG. 12 is a perspective view showing a relationship between an operation link and a relay when the electric power tool is operated.

FIG. 13 is a schematic circuit diagram showing an electric circuit diagram corresponding to another operation of the electric power tool.

FIG. 14 is a perspective view showing a relationship between an operation link and a relay when the electric power tool is operated.

FIG. 15 is a schematic circuit diagram showing an electric circuit diagram corresponding to another operation of the electric power tool.

FIG. 16 is a perspective view showing a relationship between an operation link and a relay when the electric power tool is operated.

FIG. 17 is a schematic circuit diagram showing an electric circuit diagram corresponding to another operation of the electric power tool.

FIG. 18 is a schematic circuit diagram showing an electric circuit diagram corresponding to another operation of the electric power tool.

FIG. 19 is a perspective view showing a relationship between an operation link and a relay when the electric power tool is operated.

FIG. 20 is a schematic circuit diagram showing an electric circuit diagram corresponding to another operation of the electric power tool.

FIG. 21 is a schematic circuit diagram showing an electric circuit diagram of a known electric power tool.

### DETAILED DESCRIPTION OF EMBODIMENTS

The detailed description set forth below, when considered with the appended drawings, is intended to be a description of exemplary embodiments of the present invention and is not intended to be restrictive and/or to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures, components and/or devices are shown in block diagram form in order to avoid obscuring significant aspects of the exemplary embodiments presented herein.

### Embodiment 1

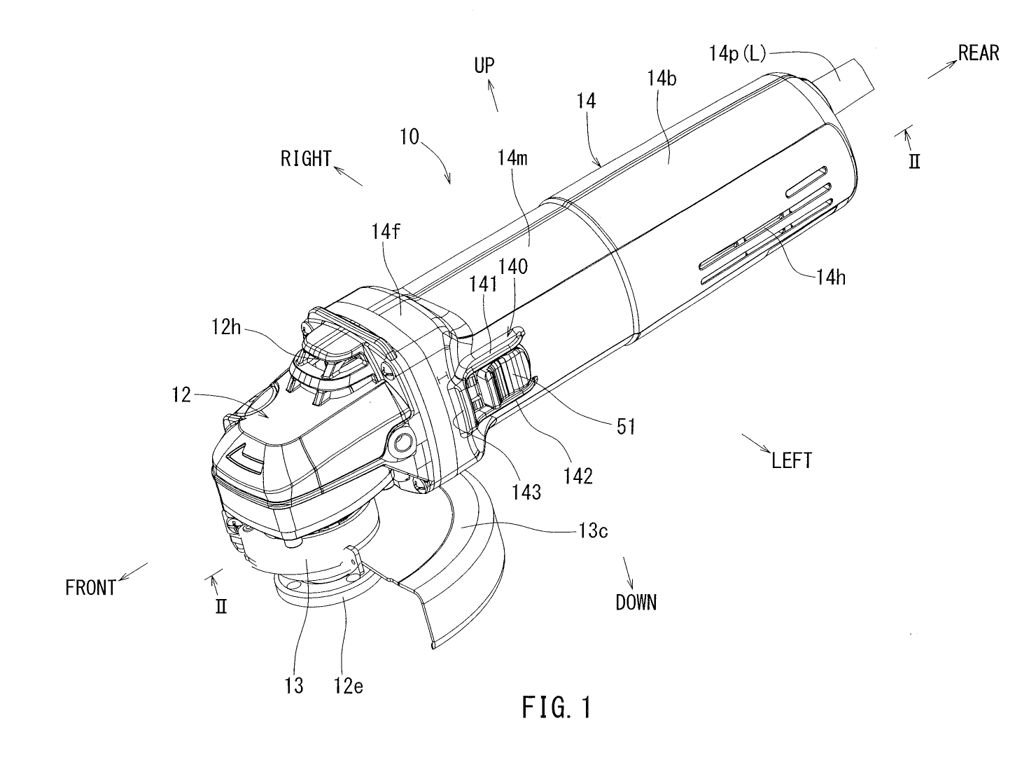

Hereinafter, an electric power tool 10 according to one exemplary embodiment of the present teachings will be described with reference to FIGS. 1 to 8. The electric power tool 10 according to the embodiment may be a disc grinder 10, which is used for grinding a surface of woods and/or metal by rotating a disc (not shown) which is a circular (disc-shaped) grindstone. The front, rear, left, right, upper, and lower sides of the drawings correspond to the front, rear, left, right, upper, and lower sides of the disc grinder 10.

<Disc Grinder 10>

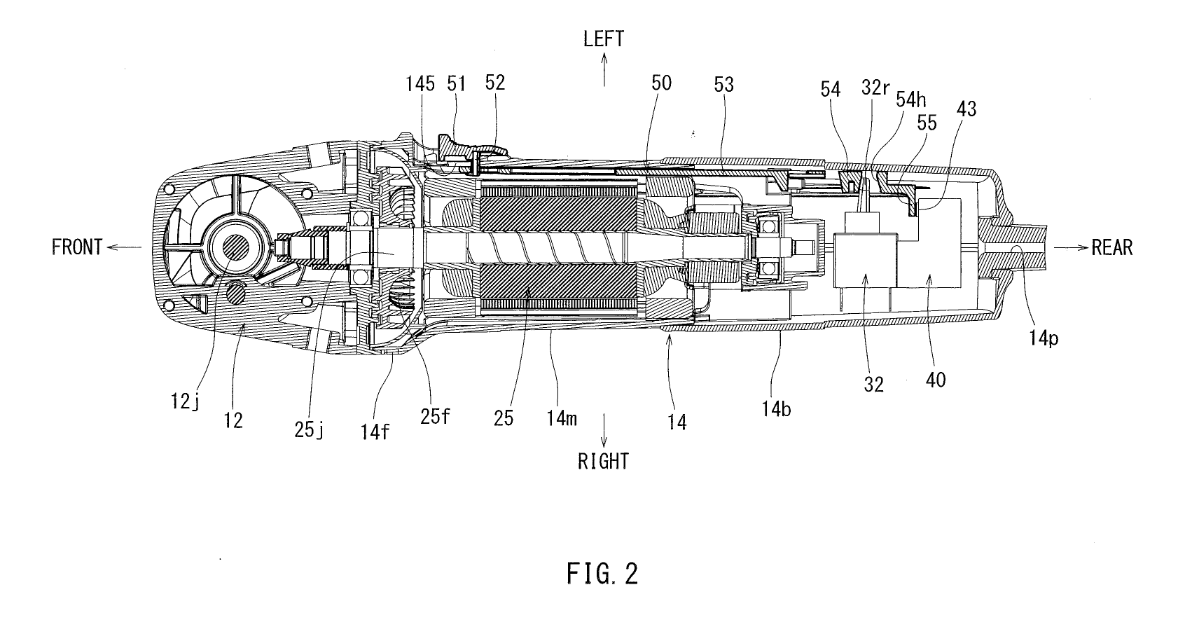

As shown in FIG. 1, the disc grinder 10 may generally include a front housing 12 and a grip 14 that is connected to a rear part of the front housing 12. A gear mechanism etc. (not shown), which rotates the disc by a rotation force from the motor 25 (refer to FIG. 20), may be housed in the front housing 12. As shown in FIG. 1, an output shaft 12j (refer to FIG. 2) of the gear mechanism may be supported by a bearing 13 located on a lower side of the front housing 12. Furthermore, as shown in FIG. 1, a circular plate portion 12e to which the disc is attached may be coaxially attached to a lower end part of the output shaft 12j that protrudes from the bearing 13. Furthermore, a cover member 13c that covers approximately an upper portion and a periphery portion of a rear half of the disc may be attached to the bearing 13. Furthermore, an outside air inlet 12h may be formed on an upper side of the front housing 12 in a direction that faces the front direction.

The grip 14 may be held by a user. As shown in FIG. 1, the grip 14 may include a front grip 14f with a large diameter that is connected to the front housing 12, a grip main body 14m with a smaller diameter than that of the front grip 14f, and a rear grip 14b with a diameter smaller than front grip 14f but slightly larger than that of the grip main body 14m. Furthermore, as shown in FIG. 1, slit-like exhaust ports 14h may be formed on a right and left side of the rear grip 14b. As shown in FIG. 2, the motor 25 may be coaxially housed in the grip main body 14m of the grip 14. Furthermore, a fan 25f may be housed in the front grip 14f of the grip 14. The fan 25f may be coaxially attached to a rotation shaft 25j of the motor 25. Accordingly, when the motor 25 is driven, the fan 25f may rotate and outside air may be taken in from the outside air inlet 12h. After the outside air taken in from the inlet 12h cools the motor 25 etc., the air may be discharged from the exhaust ports 14h of the rear grip 14b.

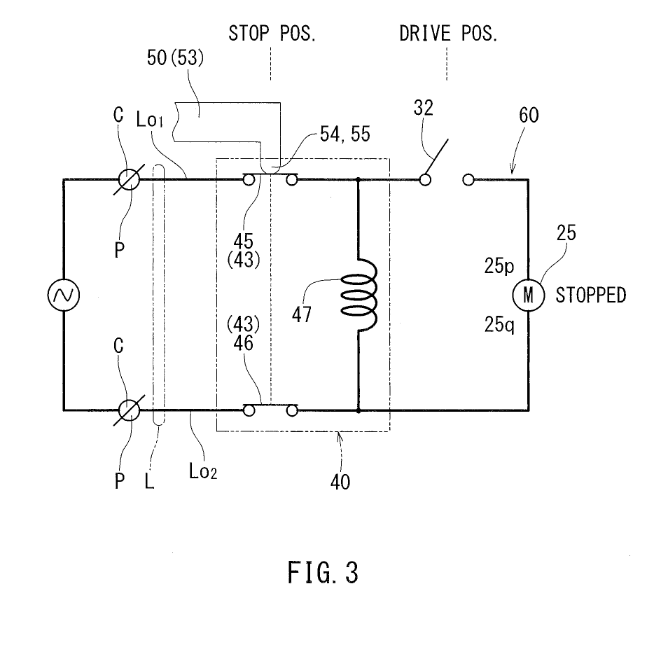

Furthermore, as shown in FIG. 2, a motor start switch 32 and a relay 40, which constitutes an electric circuit 60 (refer to FIG. 3) in which the motor 25 is driven, may be housed inside a rear part of the grip 14 (rear grip 14b). Furthermore, an operation link 50, which is used for operating the motor start switch 32 and an on-switch 43 of the relay 40, may be housed within a left end part of the grip 14 along the grip main body 14m and the rear grip 14b.

<Operation Link 50>

As shown in FIG. 2, the operation link 50 may include a slide button 51 and a link main body 53. The slide button 51 may be located at a position in which a user can operate with the thumb of the user's right hand. The link main body 53 may transfer a movement of the slide button 51 to the motor start switch 32 and the relay 40. As shown in FIG. 1, the slide button 51 may be assembled with the grip 14 to be slidably moved in a forward and rearward direction with the slide button 51 surrounded with a guide wall portion 140 formed on the left side surface of the grip 14. The guide wall portion 140 may be formed in a C shape by an upper wall 141, a lower wall 142, and a front vertical wall 143, as shown in FIG. 1. The upper wall 141 and the lower wall 142 may be formed along both the front grip 14f and the grip main body 14m such that the slide button 51 may be slidably moved in the forward and rearward direction. The front vertical wall 143, which is formed on the front grip 14f, may serve as a stopper for stopping the slide button 51 at a tool drive position (a front slide limit position). A tool stop position may correspond to a rear slide limit position of the slide button 51.

As shown in FIGS. 1 and 2, an opening 145 may be formed extending in the forward and rearward direction at a position surrounded with the guide wall portion 140. Furthermore, as shown in FIG. 2, a linkage pin 52, which links the slide button 51 and a front-end portion of the link main body 53, may be passed through the opening 145. The link main body 53 may be configured to be slidably moved in the forward and rearward direction within the grip 14 corresponding to a slide movement of the slide button 51 in the forward and rearward direction. Furthermore, a switch operation portion 54 and a pressing portion 55 may be provided at a rear part of the link main body 53. The switch operation portion 54 may switch on and/or off the motor start switch 32, and the pressing portion 55 may press the on-switch 43 of the relay 40.

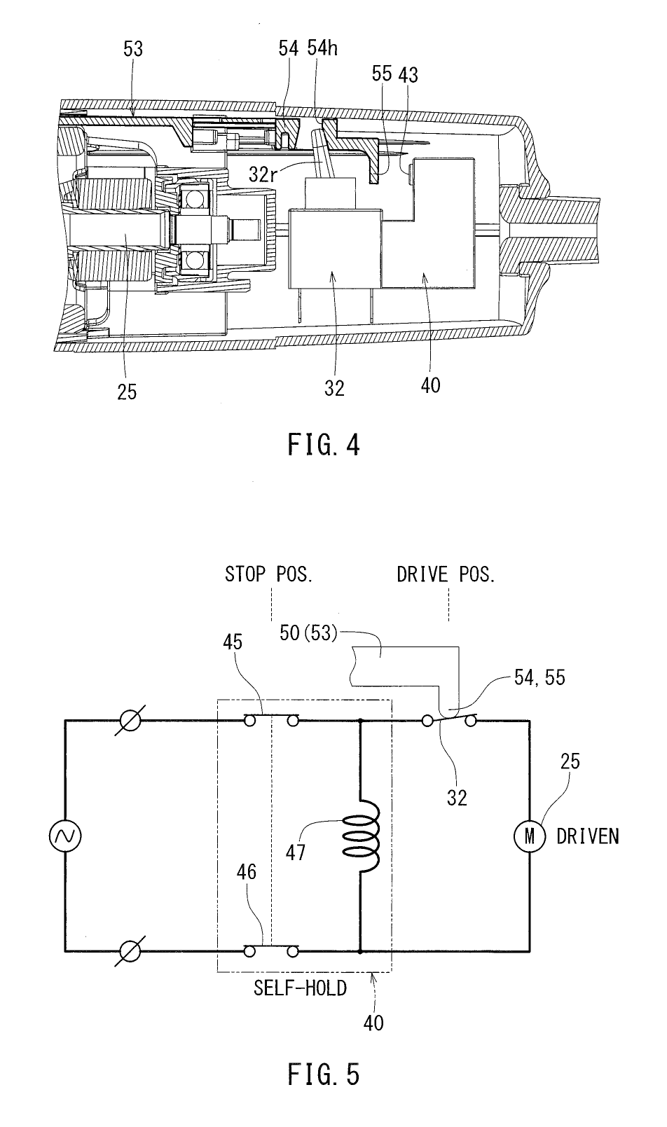

As shown in FIG. 2, an opening 54h, into which an operation lever 32r of the motor start switch 32 is inserted, may be provided with the switch operation portion 54 of the link main body 53. Furthermore, the opening 54h may be configured such that, when the link main body 53 is positioned to the rear slide limit position, i.e., the tool stop position, an end edge of the opening 54h of the switch operation portion 54 may press the operation lever 32r to an off position of the motor start switch 32. In this case, the pressing portion 55 of the link main body 53 may be configured to press an on-switch 43 of the relay 40. Furthermore, as shown in FIG. 4, when the link main body 53 is slid to the front slide limit position, i.e., the tool drive position, the end edge of the opening 54h of the switch operation portion 54 may press the operation lever 32r to an on position of the motor start switch 32. In this case, the pressing portion 55 of the link main body 53 may be located away from the on-switch 43 of the relay 40. The operation link 50 may correspond to an operation member of the present disclosure.

<Electric Circuit 60, the Relay 40, and the Motor 25>

The electric circuit 60 in which the motor 25 is driven may be housed within the grip 14. As shown in FIG. 3, the electric circuit 60 may be provided with a power cable L having a plug P, and the power cable L may be pulled out to an outside of the electric power tool 10 from the power cable outlet 14p (refer to FIG. 2), which is formed at a rear end of the grip 14. Furthermore, as shown in FIG. 3, by connecting the plug P of the power cable L to an outlet C, AC power may be applied to the electric circuit 60.

As shown in FIG. 3, one power line L01 of the power cable L may be connected to one terminal of a first contact 45, and the other terminal of the first contact 45 may be connected to both one terminal of a coil 47 of the relay 40 and one terminal of the motor start switch 32. The other terminal of the motor start switch 32 may be connected to one terminal 25p of the motor 25. Furthermore, the other power line L02 of the power cable L may be connected to one terminal of a second contact 46, and the other terminal of the second contact 46 may be connected to both the other terminal of the coil 47 of the relay 40 and the other terminal 25q of the motor 25. Accordingly, as shown in FIG. 3, the first contact 45 and the second contact 46 may be connected in series between a power source and the motor 25. Furthermore, the motor start switch 32 may be connected in series between the first contact 45 of the relay 40 and the motor 25. The coil 47 of the relay 40 may be connected in parallel with regard to the motor start switch 32 and the motor 25.

The first contact 45 and the second contact 46 of the relay 40 may be configured to interconnect with each other and may receive a biasing spring force in a direction to open the contacts. Furthermore, by the on-switch 43 of the relay 40 being pressed by the pressing portion 55 of the operation link 50 (the link main body 53), the first contact 45 and the second contact 46 may be closed against the spring force. Furthermore, in so being closed, when the coil 47 of the relay 40 is energized, the first contact 45 and the second contact 46 may remain in a closed state by an electromagnetic force of the coil 47. Furthermore, under a condition where an energization of the coil 47 is released, when the pressing portion 55 of the operation link 50 (the link main body 53) is located away from the on-switch 43, the first contact 45 and the second contact 46 may be subsequently re-opened by the described biasing spring force.

<Operation of the Disc Grinder 10>

Next, an operation of the disc grinder 10 will be explained with reference to FIGS. 2 to 8. As shown in FIG. 2, when the slide button 51 of the operation link 50 in the disc grinder 10 is located at the tool stop position (rear slide limit position), the pressing portion 55 of the operation link 50 (link main body 53) presses the on-switch 43 of the relay 40. Accordingly, as shown in FIG. 3, both the first contact 45 and the second contact 46 of the relay 40 may be closed against the spring force. Under this condition, when the plug P of the power cable L of the disc grinder 10 is connected to the outlet C, the coil 47 of the relay 40 may be energized and both the first contact 45 and the second contact 46 may remain closed after the initial closing from the pressing portion by the electromagnetic force. Furthermore, as shown in FIGS. 2 and 3, under the condition where the slide button 51 of the operation link 50 is located at the tool stop position (the rear slide limit position), the switch operation portion 54 of the link main body 53 may turn off the motor start switch 32. Accordingly, the motor 25 may be remained in the stopped state.

Next, when the slide button 51 of the operation link 50 is pressed in the forward direction, the link main body 53 may be slid in the forward direction together with the slide button 51. Furthermore, as shown in FIGS. 4 and 5, the pressing portion 55 of the link main body 53 may be moved away from the on-switch 43 of the relay 40. However, since the coil 47 of the relay 40 is energized, both the first contact 45 and the second contact 46 may remain in the closed state by the electromagnetic force of the coil 47. Furthermore, as shown in FIGS. 4 and 5, when the slide button 51 of the operation link 50 reaches the tool drive position (the front slide limit position), the switch operation portion 54 of the link main body 53 may turn on the motor start switch 32. Accordingly, electric power may be applied to the motor 25 in the electric circuit 60, which causes the motor 35 to run.

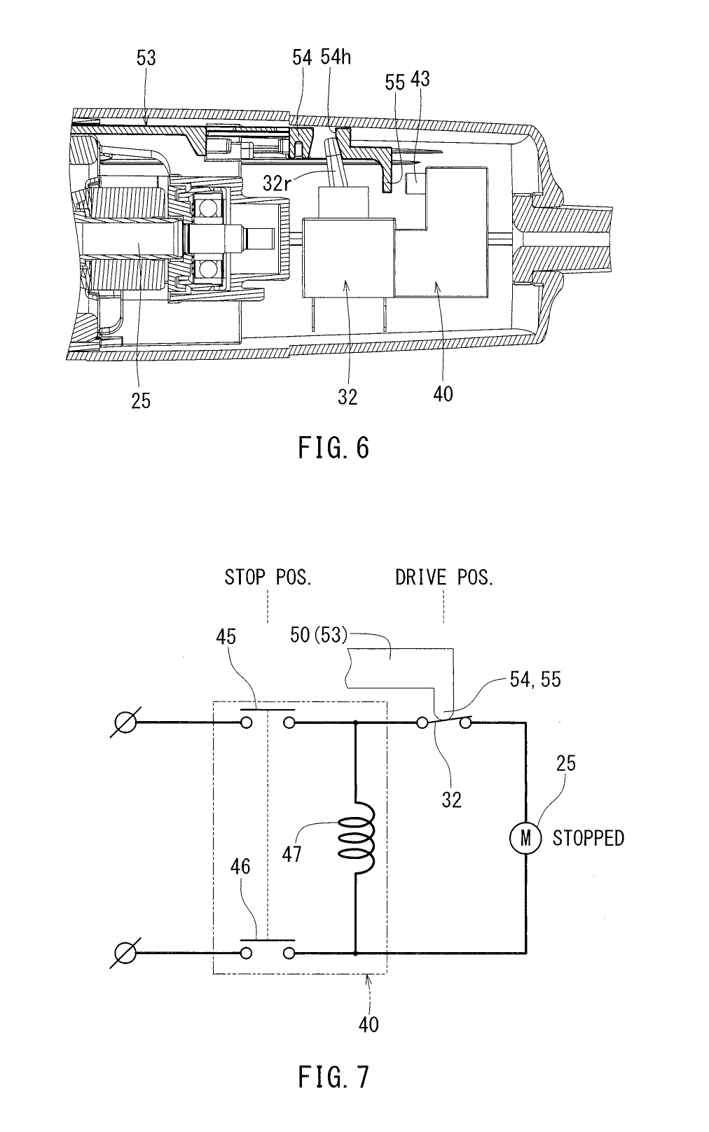

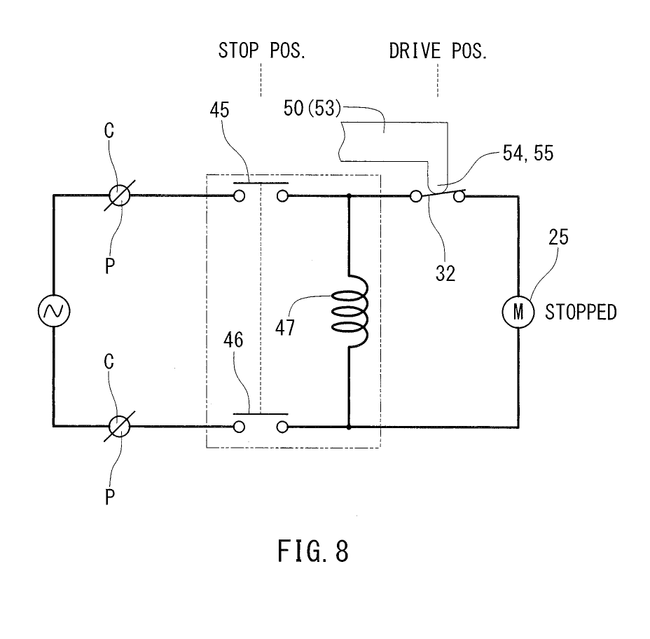

Under this condition, for example, if the plug P of the power cable L is pulled out from the outlet C, energization of the coil 47 of the relay 40 may be released. Furthermore, in a state where the slide button 51 of the operation link 50 is located at the tool drive position, the pressing portion 55 of the link main body 53 may be away from the on-switch 43 of the relay 40. Accordingly, when the energization of the coil 47 of the relay 40 is released, both the first contact 45 and the second contact 46 may be opened by the spring force, as shown in FIGS. 6 and 7. Thus, the motor 25 may stop. Under this condition, even if the plug P of the power cable L is connected to the outlet C again, the coil 47 may not be energized because both the first contact 45 and the second contact 46 are opened, as shown in FIG. 8. As a result, the motor 25 may be remained in the stopped state. In other words, recovery of the power supply after the interruption may not cause the motor to restart, which can reliably ensure safety of the user.

<Benefit of the Disc Grinder 10 of the Present Disclosure>

According to the disc grinder 10 of the present disclosure, prior to a movement of the operation link 50 (operation member) to the tool drive position, the pressing portion 55 of the operation link 50 may press the on-switch 43 of the relay 40 and thus both the first contact 45 and the second contact 46 may be closed. Accordingly, the coil 47 of the relay 40 may be energized and both the first contact 45 and the second contact 46 may remain in the closed state due to the electromagnetic force of the coil 47. Subsequently, when the operation link 50 is moved to the tool drive position, the pressing portion 55 of the operation link 50 may transition to a position away from the on-switch 43 of the relay 40. However, when the operation link 50 is moved to the tool drive position, both the first contact 45 and the second contact 46 may remain in the closed state because of the electromagnetic force of the energized coil 47, and thus the motor 25 may run. Under this condition, if the plug P is pulled out from the outlet C, this causes the power supply to be interrupted, where the energization of the coil 47 of the relay 40 may then be released, causing both the first contact 45 and the second contact 46 to be opened. Accordingly, the motor 25 may stop. Under this condition, even if the plug P is connected to the outlet C again, both the first contact 45 and the second contact 46 would remain in the opened state because the operation link 50 is located at the tool drive position and away from the on-switch 43 of the relay 40, and it cannot close the first and second contacts. In other words, even if the plug P is connected to the outlet C in a condition where the operation link 50 is located at the tool drive position, the motor 25 may be prevented from being restarted. In this way, the electric power tool can be prevented from restarting by use of the relay 40 instead conventional means requiring use of a heating element such as a bi-directional thyristor, etc.

### Embodiment 2

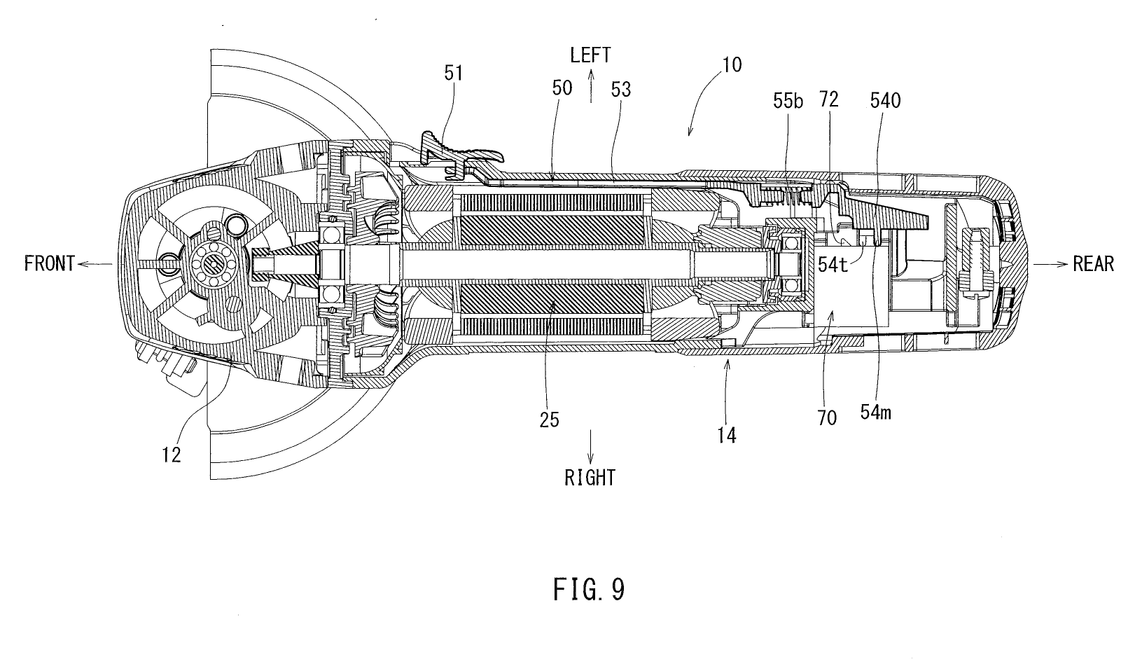

Hereinafter, an electric power tool (disc grinder 10) according to another exemplary embodiment of the present teachings will be described with reference to FIGS. 9 to 20. As shown in FIG. 9, the disc grinder 10 of the present embodiment may not have the motor start switch 32 used in the embodiment 1. Furthermore, in the embodiment 2, a relay 70 having an off-switch may be used instead of the relay 40. A part of the link main body 53 of the operation link 50 may be modified accordingly. In the embodiment 2, configurations other than the above may be the same as in the embodiment 1, and accordingly explanation will be deleted with the same reference numerals being applied.

<Relay 70>

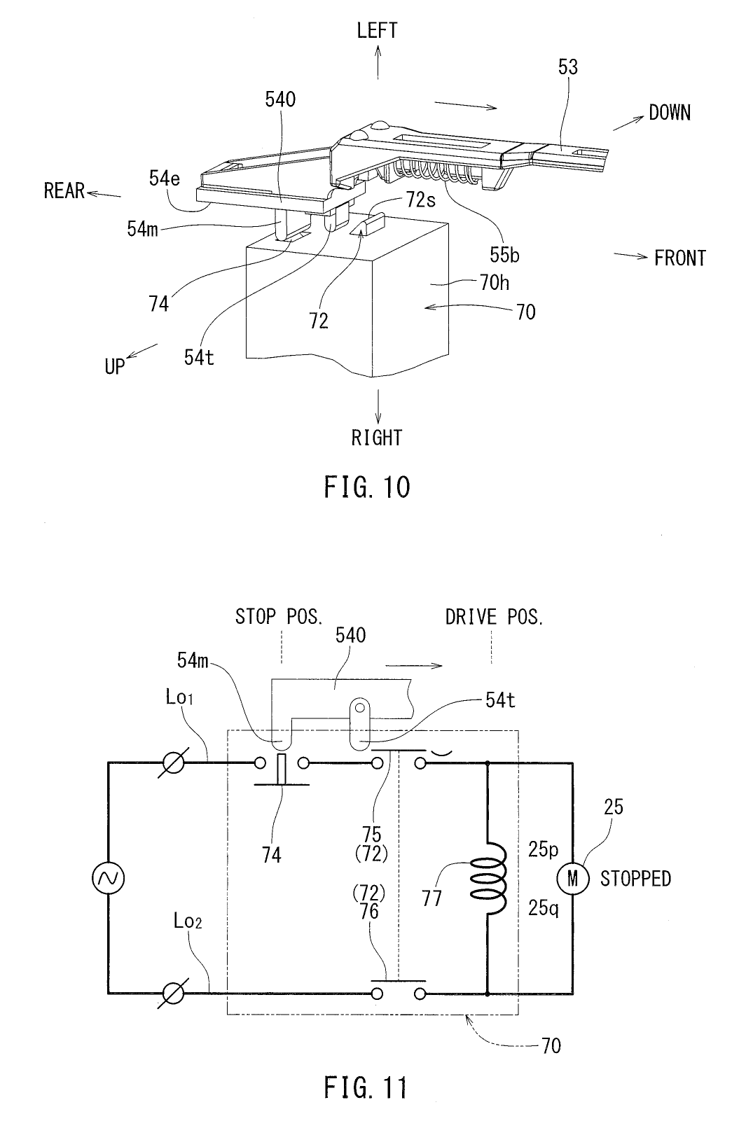

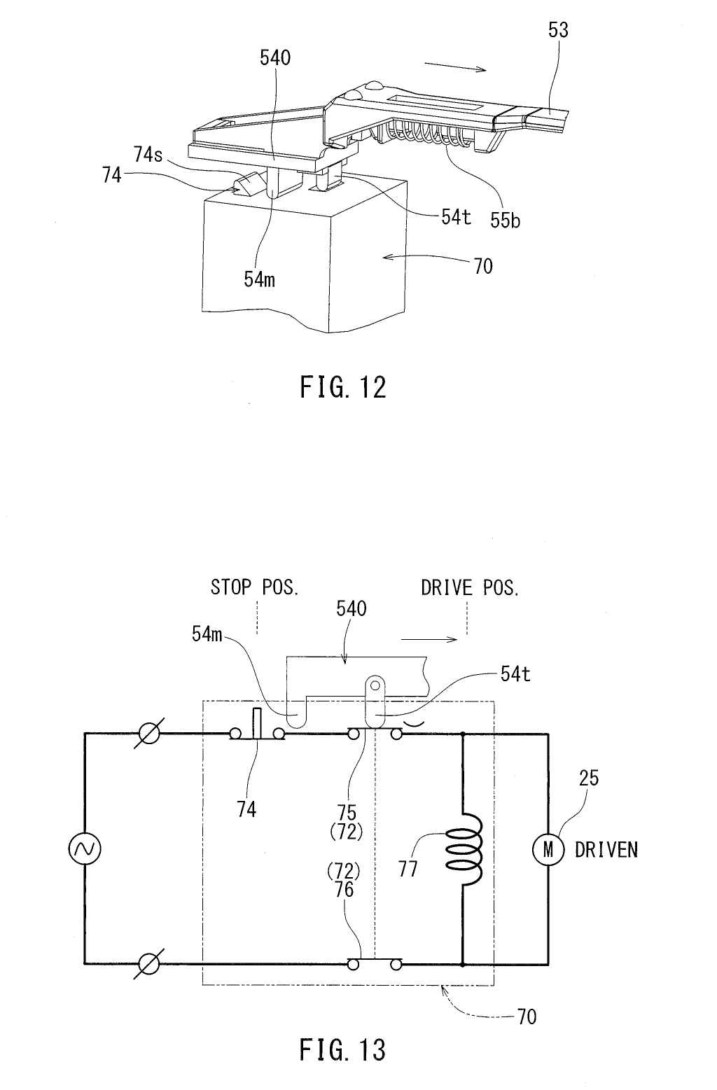

As shown in FIGS. 10 and 11, the relay 70 of the disc grinder 70 according to the embodiment 2 may have an on-switch 72 and an off-switch 74. As shown in FIG. 10, the on-switch 72 may be formed to protrude from a relay housing 70h in a lower part of the front side on a left end surface of the relay housing 70h. Furthermore, a slant surface 72s, with which an on-side pressing protrusion 54t (described later) of the operation link 50 comes into contact, may be formed on a rear side of the protruding portion of the on-switch 72. As shown in FIGS. 12 and 13, the on-switch 72 may press both the first contact 75 and the second contact 76 toward a closing direction (an on-direction) against the spring force by receiving a pressing force of the on-side pressing protrusion 54t of the operation link 50. Furthermore, as shown in FIGS. 10 and 11, when the on-switch 72 is not pressed by the on-side pressing protrusion 54t of the operation link 50, the on-switch 72 may remain in a protruded state (an off-state) by receiving the biasing spring force of the first contact 75 and the second contact 76.

As shown in FIGS. 10 and 12, the off-switch 74 may be formed to protrude from the relay housing 70h in an upper part of the rear side on the left end surface of the relay housing 70h. Furthermore, a slant surface 74s, with which an off-side pressing protrusion 54m (described later) of the operation link 50 comes into contact, may be formed on a front side of the protruding portion of the off-switch 74. As shown in FIGS. 10 and 11, the off-switch 74 may open the contacts 75, 76 by receiving a pressing force of the off-side pressing protrusion 54m of the operation link 50 to cause energization of the coil 77 of the relay 70 to release. The off-switch 74 may be biased in a direction to close the contacts 75, 76 by a spring force of the relay 70 when not pressed, and accordingly, when the off-switch 74 is not pressed by and is spaced apart from the off-side pressing protrusion 54m of the operation link 50, the off-switch 74 may close the contacts 75, 76 and remain in a protruded state (on state).

<Operation Link 50>

As shown in FIG. 10, a relay operation portion 540 may be linked to a rear end part of the link main body 53 of the operation link 50 via a helical spring 55b. Because of this construction, the relay operation portion 540 may be moved in the forward and rearward direction according to an amount of deformation of the helical spring 55b with respect to the link main body 53. Furthermore, the relay operation portion 540 may be slid forward and rearward along the left end surface of the relay housing 70h by a respective corresponding slide movement of the link main body 53 of the operation link 50 in the forward and rearward direction.

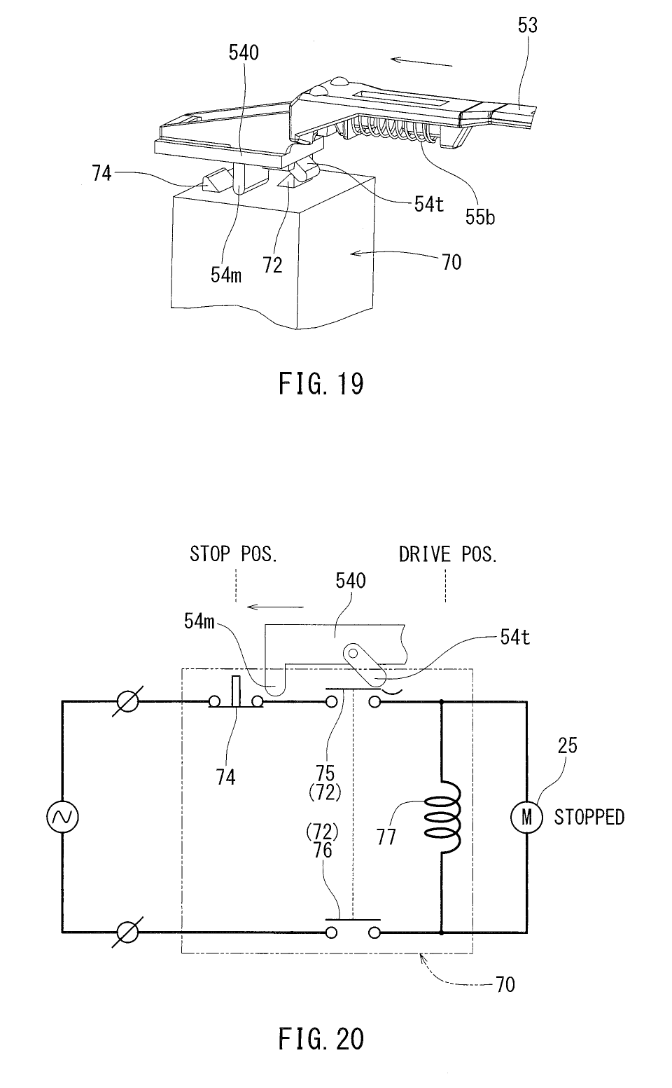

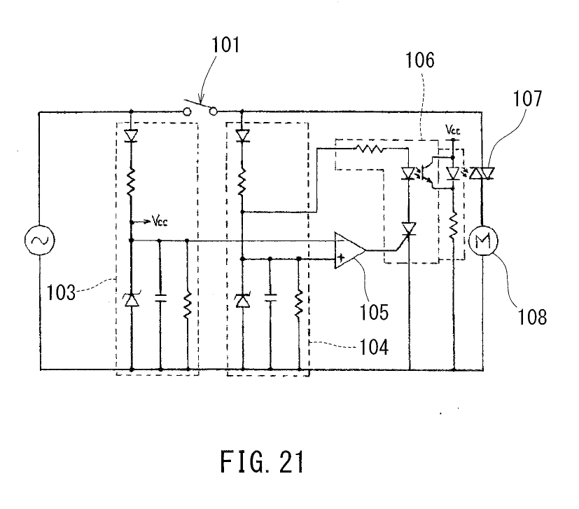

The relay operation portion 540 may be provided with a reverse-side flat surface 54e that faces the left end surface of the relay housing 70h. Furthermore, as shown in FIG. 10, the off-side pressing protrusion 54m may be provided on the reverse-side flat surface 54e protruding at right angles to the reverse-side flat surface 54e (erected state) at an upper side close to the center of the reverse-side flat surface 54e. Furthermore, the on-side pressing protrusion 54t may be provided on the reverse-side flat surface 54e protruding at right angles to the reverse-side flat surface 54e (erected state) at a position close to a lower part of the reverse-side flat surface 54e in front of the off-side pressing protrusion 54m. The on-side pressing protrusion 54t may be assembled with the reverse-side flat surface 54e of the relay operation portion 540 such that the on-side pressing protrusion 54t remains in the erected state against a pressing force from a forward direction but is folded in a forward direction against a pressing force from a rearward direction, as shown in, for example, FIGS. 12 and 19.

As shown in FIGS. 10 and 12, the off-side pressing protrusion 54m of the relay operation portion 540 may be positioned such that when the operation link 50 (link main body 53) is slid to the tool stop position in the rearward direction, the slant surface 74s of the off-switch 74 of the relay 70 may be pressed from the forward direction by the off-side pressing protrusion 54m. By the slant surface 74s of the off switch 74 of the relay 70 being pressed from the forward direction by the off-side pressing portion 54m of the relay operation portion 540, the off-switch 74 may be pressed inside the relay housing 70h. As a result, the contact of the off-switch 74 may be opened against the biasing spring force of the relay 70. During the slide movement of the link main body 53 of the operation link 50 in the forward and rearward direction, the off-side pressing protrusion 54m of the relay operation portion 540 may be arranged not to interfere with the on-switch 72 of the relay 70.

As shown in FIG. 10, when the operation link 50 is located at the tool stop position, the on-side pressing protrusion 54t of the relay operation portion 540 may be at the rear of the on-switch 72 of the relay 70. When the operation link 50 is slid forward from the tool stop direction, the on-side pressing protrusion 54t of the relay operation portion 540 may be brought into contact with the slant surface 72 of the on-switch 72s of the relay 70 from the rear direction. At this time, since the on-side pressing protrusion 54t of the relay operation portion 540 is pressed from the front direction, the on-side pressing protrusion 54t may remain in the erected state, as described above. Accordingly, the on-side pressing protrusion 54t may press the slant surface 72s of the on-switch 72 of the relay 70, and the on-switch 72 may be pressed down into the inside of the relay housing 70h, as shown in FIG. 12. As a result, the first contact 75 and the second contact 76 of the relay 70 may be closed against the biasing spring force of the relay 70.

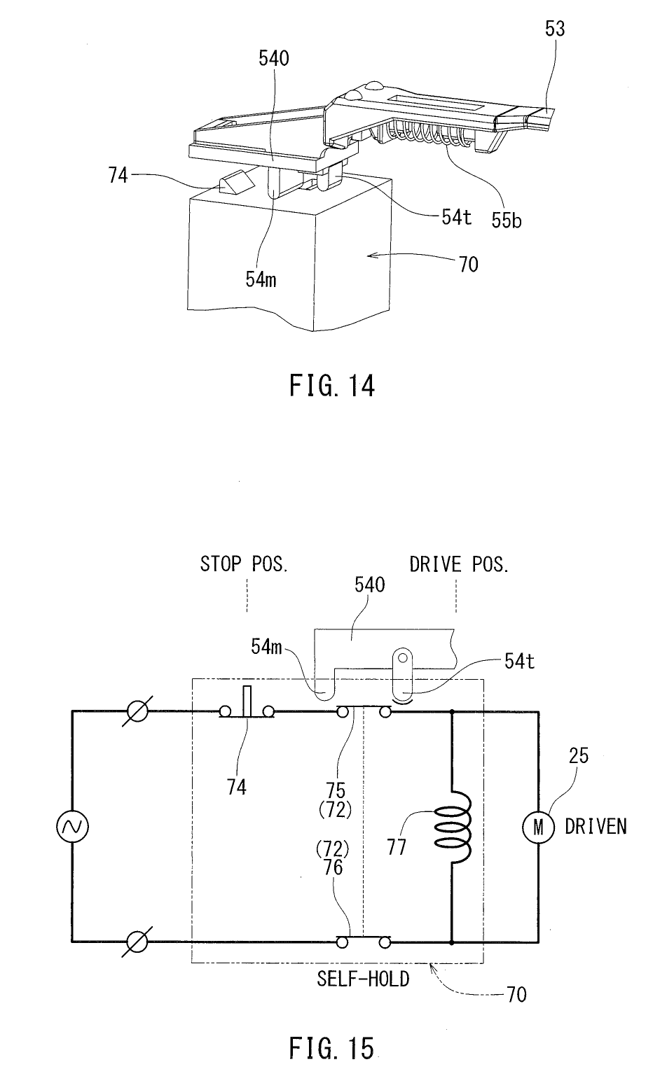

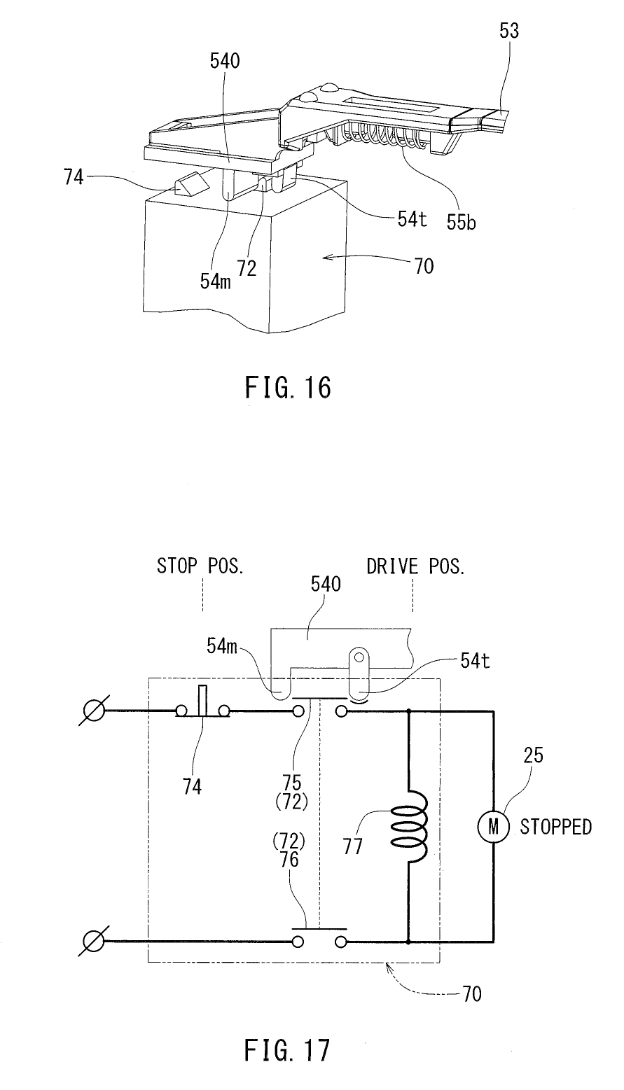

When the operation link 50 is slid forward even further from the above state as shown in FIG. 14, the on-side pressing protrusion 54t of the relay operation portion 540 may traverse the on-switch 72 of the relay 70. When the operation link 50 reaches the tool drive position, the on-side pressing protrusion 54t of the relay operation portion 540 may be moved away from the on-switch 72 of the relay 70 and located in front of the on-switch 72, as shown in FIGS. 14 and 16. When the operation link 50 is slid rearward from the tool drive position from the above state, the on-side pressing protrusion 54t of the relay operation portion 540 may be brought into contact with the on-switch 72 of the relay 70 from the front direction. As a result, the on-side pressing protrusion 54t may be folded in a forward direction, as shown in FIG. 19. Accordingly, the on-switch 72 of the relay 70 may not prevent the operation link 50 from being furthermore slid rearward.

<Operation of the Disc Grinder 10>

Next, an operation of the disc grinder 10 will be explained. When the slide button 51 of the operation link 50 in the disc grinder 10 is located at the tool stop position (rear slide limit position), the off-side pressing protrusion 54m of the operation link 50 (the relay operation portion 540) may press the off-switch 74 of the relay 70, as shown in FIG. 10. Accordingly, as shown in FIG. 11, the contact of the off-switch 74 of the relay 70 may be opened against the biasing spring force of the relay 70. Furthermore, as shown in FIG. 10, the on-side pressing protrusion 54t of the relay operation portion 540 may be located away from the on-switch 72 of the relay 70, and accordingly both the first contact 75 and the second contact 76 may remain in an opened state through the biasing spring force of relay 70. As a result, even if the plug P of the power cable L of the disc grinder 10 is connected to the outlet C, the motor 25 may remain in a stopped state.

Next, the slide button 51 of the operation link 50 is pressed forward, the link main body 53 may be slid forward together with the slide button 51. As shown in FIGS. 12 and 13, the off-side pressing protrusion 54m of the relay operation portion 540 may be moved away from the off-switch 74 of the relay 74. Because of this movement, the off-switch 74 of the relay 70 may be returned to a position in which the contact of the off-switch 74 is closed by the spring force of the relay 70. When the link main body 53 is furthermore slid forward, the on-side pressing protrusion 54t of the relay operation portion 540 may press the on-switch 72 of the relay 70, as shown in FIG. 13. Because of this movement, the first contact 75 and the second contact 76 of the relay 70 may be closed against the biasing spring force of the relay 70, such that the coil 77 of the relay 70 may be energized and electric power may be supplied to the motor 25 to drive the motor 25. Furthermore, when the link main body 53 of the operation link 50 reaches the tool drive position (the front slide limit position), the on-side pressing protrusion 54t of the relay operation portion 540 may be moved away from the on-switch 72 of the relay 70, as shown in FIGS. 14 and 15. At this time, the first contact 75 and the second contact 76 of the relay 70 remain closed due to the electromagnetic force of the coil 77. As a result, the motor 25 may remain in a driven state and is able to run.

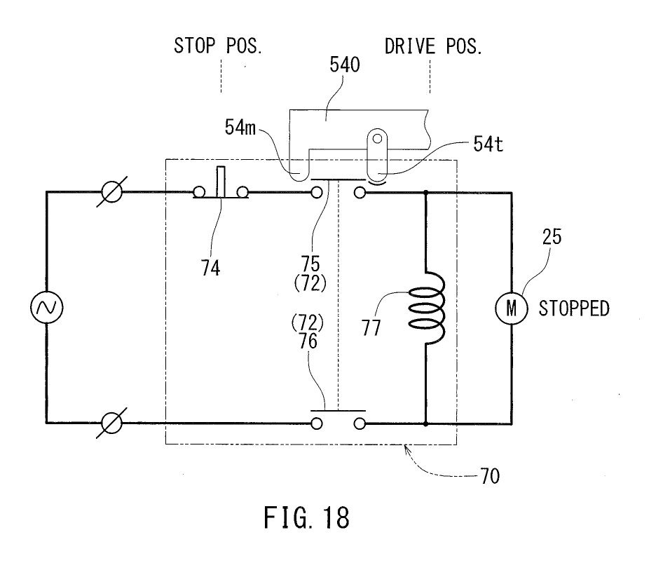

Under this condition, if the plug P of the power cable L is pulled out from the outlet C, as shown in FIG. 17, energization of the coil 77 of the relay 70 may be released and the motor 25 may stop. When the slide button 51 of the operation link 50 is located at the tool drive position, the on-side pressing protrusion 54t of the relay operation portion 540 is located away from the on-switch 72 of the relay 70, and accordingly when energization of the coil 47 of the relay 40 is released, both the first contact 75 and the second contact 76 may be opened by the biasing spring force of the relay 70. Accordingly, as shown in FIG. 18, even when the plug P of the power cable L is connected back to the outlet C again, the motor 25 may remain in the stopped state, because both the first contact 75 and the second contact 76 of the relay 70 are opened. In this way, even if electric power is recovered after power interruption, the motor 25 may be prevented from restarting.

As shown in FIGS. 19 and 20, when the link main body 53 of the operation link 50 is slid rearward from the tool drive position, the on-side pressing protrusion 54t of the relay operation portion 540 may be brought into contact with the on-switch 72 of the relay 70 to fold forward. Because of this movement, the link main body 53 of the operation link 50 is not prevented from sliding rearward. Furthermore, as shown in FIGS. 10 and 11, when the operation link 50 is returned to the tool stop position, the off-side pressing protrusion 54m of the relay operation portion 540 may press the off-switch 74 of the relay 70. Accordingly, even in a case where the motor 25 is driven before the operation link 50 is moved to the tool stop position, energization of the coil 47 may be released and both the first contact 75 and the second contact 76 may be opened by the biasing force from the relay to stop the motor 25 from running.

In this way, under a condition where the operation link 50 is located at the tool stop position, when the plug P of the power cable L is connected to the outlet C, the coil 77 of the relay 70 may not be energized, and thus standby power can be reduced. Furthermore, since the relay operation portion 540 may be linked to the link main body 53 of the operation link 50 via the helical spring 55b, the relay operation portion 540 can be reliably returned to the tool stop position by the corresponding movement of the main body, due to the spring force.

The present invention is not limited to the embodiments discussed above and may be further modified without departing from the scope and spirit of the present teachings For example, in the embodiments discussed above, the disc grinder 10 may be driven by AC power. However, the present teaching may be applied to a disc grinder etc. that is driven by DC power. Furthermore, in the electric circuit 60 of the embodiments discussed above, the first contact 45 (75) of the relay 40 (70) may be located in one power line L01, and the second contact 46 (76) may be located in the other power line L02. However, it may be configured such that the contact 45 (75) of the relay 40 (70) is located in at least one of the power lines L01 and L02. Furthermore, though the present teachings are applied to the disc grinder 10, they may also be applied to electric power tools other than the disc grinder 10, in which the slide button 51 of the operation link 50 is held at the tool stop position.

What is claimed is:

1. An electric power tool, comprising:
a relay having a coil, a contact, and an on-switch, the relay configured such that the coil is energized when the contact is closed by the on-switch being pressed, the contact being held in a closed state by an electromagnetic force of the coil when the coil is energized;
an electric circuit in which electric power from a power source is supplied to a motor and the coil of the relay, the relay contact being connected in series between the power source and the motor; and
an operation member configured to be moved in a reciprocating manner between a tool stop position at which the motor stops and a tool drive position at which the motor runs, where the operation member is configured to be located away from the on-switch of the relay at the tool drive position, and is configured to press the on-switch at a position other than the tool drive position.

2. The electric power tool according to claim 1, further comprising a motor start switch that is connected in series to the contact of the relay, wherein:
the electric circuit is configured such that electric power is supplied to the motor when the contact of the relay is closed and the motor start switch is turned on; and
the operation member is configured to turn on the motor start switch at the tool drive position and to press the on-switch of the relay at the tool stop position, further wherein the operation member is configured to turn off the motor start switch when the operation member is moved away from the tool drive position.

3. The electric power tool according to claim 2, wherein:
the operation member includes an opening into which an operation lever of the motor start switch is inserted and also includes a pressing portion that presses the on-switch of the relay;
wherein when the operation member is located at the tool stop position, the operation lever of the motor start switch is held at an off position within the opening and the pressing portion presses the on-switch of the relay; and
during a movement of the operation member toward the tool drive position, the operation lever of the motor start switch is moved to an on position by being pushed by an end edge of the opening and the pressing portion is moved away from the on-switch of the relay.

4. The electric power tool according to claim 1, wherein
the relay includes an off-switch that is configured such that when the off-switch is pressed, energization of the coil is released to open the contact;
the electric circuit is configured to supply electric power to the motor when the contact of the relay is closed;
the operation member presses the off-switch of the relay when the operation member is located at the tool stop position; and
during a movement of the operation member from the tool stop position to the tool drive position, the operation member while progressively moving away from the off-switch of the relay, pushes the on-switch of the relay, and further moves away from the on-switch of the relay, reaching the tool drive position.
